(19) United States
(12) Patent Application Publication
(10) Pub. No.: US 2024/0112193 A1
(43) Pub. Date: Apr. 4, 2024

(54) METHOD AND DEVICE FOR TRANSMITTING DATA BASED ON BLOCKCHAIN

(71) Applicant: Samsung Electronics Co., Ltd., Suwon-si (KR)

(72) Inventors: Yongjoon KIM, Suwon-si (KR); Younghwan RYU, Suwon-si (KR); Sungwook WON, Suwon-si (KR); Geunseok JANG, Suwon-si (KR); Yonggil HAN, Suwon-si (KR)

(21) Appl. No.: 18/452,228

(22) Filed: Aug. 18, 2023

Related U.S. Application Data
(63) Continuation of application No. PCT/KR2023/008911, filed on Jun. 27, 2023.

(30) Foreign Application Priority Data
Sep. 29, 2022 (KR) 10-2022-0124192
Oct. 27, 2022 (KR) 10-2022-0140164

(51) Int. Cl. G06Q 20/40; G06Q 20/02

(52) U.S. Cl. CPC G06Q 20/409; G06Q 20/02; G06Q 20/4016

(57) ABSTRACT

An electronic device is provided. The electronic device includes a communication circuit, a memory configured to store a partial ledger including a part of a full ledger for a blockchain network or the full ledger, and a processor. The processor is configured to generate a first transaction using a smart contract including shared data of the electronic device and information on an external user to receive the shared data, request to transmit the first transaction to the blockchain network, verify the first transaction using a node creating at least one block corresponding to each of at least one transaction, transmit the first transaction to the blockchain network, create a first block corresponding to the first transaction, verify a second transaction based on receiving a second transaction, execute the smart contract, and to create a second block corresponding to the second transaction.

### CROSS-REFERENCE TO RELATED APPLICATION(S)

This application is a continuation application, claiming priority under § 365(c), of an International application No. PCT/KR2023/008911, filed on Jun. 27, 2023, which is based on and claims the benefit of a Korean patent application number 10-2022-0124192, filed on Sep. 29, 2022, in the Korean Intellectual Property Office, and of a Korean patent application number 10-2022-0140164, filed on Oct. 27, 2022, in the Korean Intellectual Property Office, the disclosure of each of which is incorporated by reference herein in its entirety.

### TECHNICAL FIELD

The disclosure relates to an electronic device and a method for transmitting data based on a blockchain.

### BACKGROUND ART

A blockchain is a data structure that stores information in a block and that continuously connects the block to existing blocks to constitute a chain form and may mean a distributed data structure using a peer to peer (P2P) network system rather than a data storage structure, such as a database operating on a single computer. The blockchain may enable all nodes to store the same data block for security.

An electronic device may partially (e.g., partial ledger) store blocks related to nodes among distributed ledgers for a blockchain network, and ledgers related to blocks or may store the entire (or full ledger) of a distributed ledger for a blockchain network. For example, the distributed ledger may include a state database and at least one block including each of at least one transaction in a blockchain network. At least one block included in each distributed ledger may be each connected using a hash field. Therefore, in the case that the connection through the hash field is broken or a different distributed ledger is discovered, blockchain nodes may doubt reliability and validity of the corresponding block.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

When data are exchanged between devices or between servers, it is necessary to define and proceed with each other's specifications, thus, it may take a lot of time and effort. When an application or desired data is changed, the application or server may need to be updated. Further, in the case that an interworking device is changed, the device may need to be updated.

Further, even if data is exchanged between devices or between servers, it may be difficult to prove whether the data is reliable. It may be difficult for a device or server corresponding to a third party to identify the transmission history of data.

Aspects of the disclosure are to address at least the above-mentioned problems and/or disadvantages and to provide at least the advantages described below. Accordingly, an aspect of the disclosure is to provide an electronic device and a method for transmitting data based on a blockchain.

Additional aspects will be set forth in part in the description which follows and, in part, will be apparent from the description, or may be learned by practice of the presented embodiments.

### Solution to Problem

In accordance with an aspect of the disclosure, an electronic device is provided. The electronic device includes a communication circuit, a memory configured to store a partial ledger including a part of a full ledger for a blockchain network or the full ledger, and a processor, wherein the ledger includes at least one block corresponding to each of at least one transaction in which the electronic device participates in a consensus. The processor is configured to generate a first transaction using a smart contract including shared data of the electronic device and information on an external user to receive the shared data, to request to transmit the first transaction to the blockchain network, to verify the first transaction using a node creating at least one block corresponding to each of at least one transaction in which the electronic device participates in a consensus, to transmit the first transaction to the blockchain network based on identifying reliability of the first transaction, to create a first block corresponding to the first transaction, to verify a second transaction based on receiving a second transaction including a request for provision of shared data from the blockchain network, to execute the smart contract based on identifying reliability of the second transaction, and to create a second block corresponding to the second transaction.

In accordance with another aspect of the disclosure, a server is provided. The server includes a communication circuit, a memory configured to store a partial ledger including a part of a full ledger or the full ledger, and a processor. The processor is configured to receive a first transaction including a smart contract related to shared data and information on an external user to receive the shared data from a first node of a first external device, to request verification to the first node whether information on an external user to receive the shared data in the smart contract and information on a second external device matches based on receiving a second transaction including a request for provision of the shared data from a second node of the second external device, and to transmit the shared data to the second external device based on the second external device and information on an external user to receive the shared data being matched in the smart contract.

In accordance with another aspect of the disclosure, a method of managing data transmission of an electronic device is provided. The method includes generating a first transaction using a smart contract including shared data of the electronic device and information on an external user to receive the shared data, requesting to transmit the first transaction to a blockchain network, verifying the first transaction and transmitting the first transaction to the blockchain network based on identifying reliability of the first transaction, creating a first block corresponding to the first transaction, verifying the second transaction based on receiving a second transaction including a request for provision of the shared data from the blockchain network, and executing the smart contract based on identifying reliability of the second transaction and creating a second block corresponding to the second transaction.

### Advantageous Effects of Invention

According to an embodiment of the disclosure, when necessary data are transferred between applications, the electronic device can safely transmit and receive necessary data by recording it in a ledger without separate update.

According to an embodiment of the disclosure, the electronic device can easily track and manage data transmission details by recording contents in a ledger when necessary data is exchanged between applications.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating hardware of an electronic device according to an embodiment of the disclosure;

FIG. 3A is a diagram illustrating a mobile blockchain system according to an embodiment of the disclosure;

FIG. 3B is a block diagram illustrating a constitution of a blockchain network according to an embodiment of the disclosure;

FIG. 4 is an operation flow diagram illustrating a relationship between an electronic device, a blockchain, and an external device according to an embodiment of the disclosure;

FIG. 5A illustrates a data transmission situation through a blockchain of an electronic device according to an embodiment of the disclosure;

FIG. 5B illustrates a situation in which an electronic device rejects a data transmission request of an application that is not permitted according to an embodiment of the disclosure; and

FIG. 6 is a flowchart illustrating a method of managing data of an electronic device according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

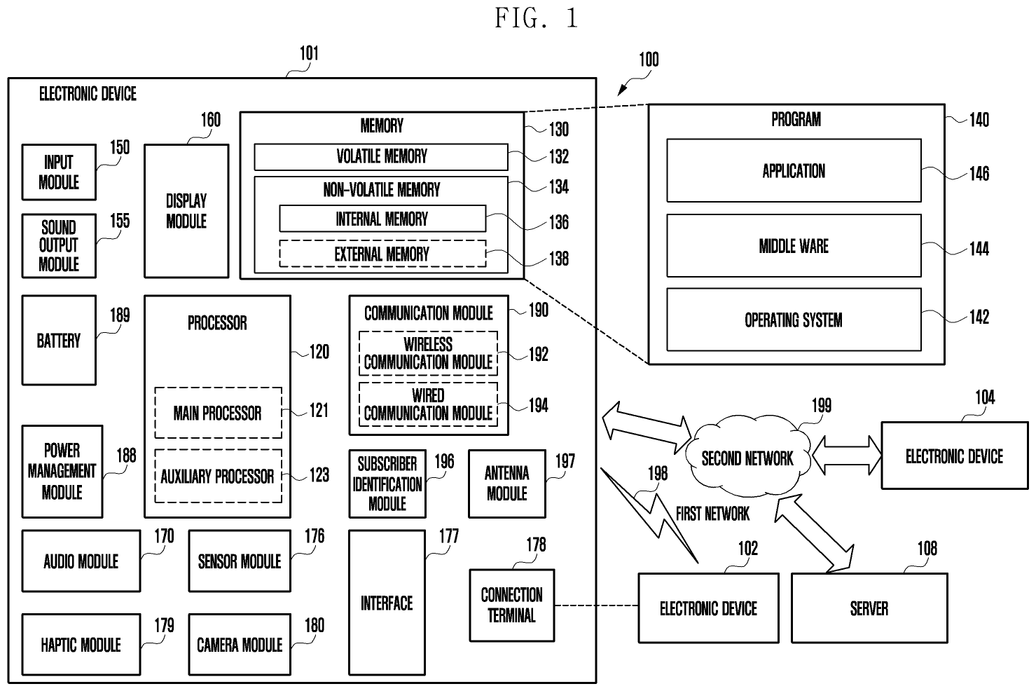

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

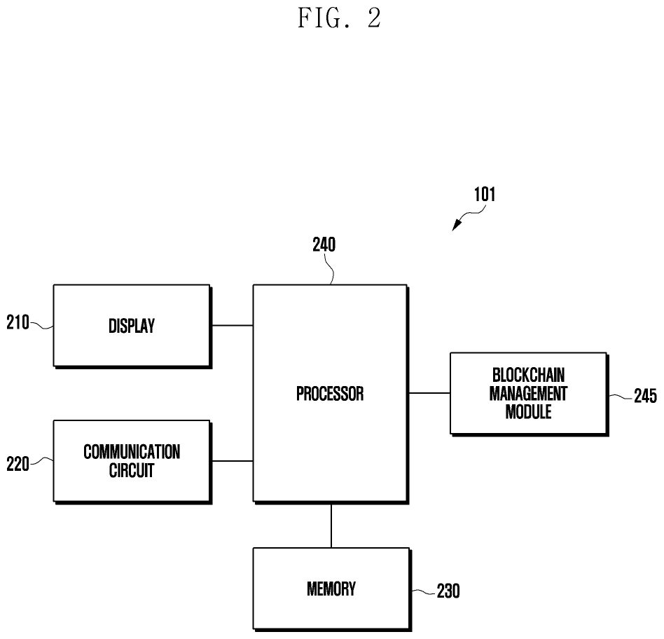

FIG. 2 is a block diagram illustrating hardware of an electronic device according to an embodiment of the disclosure.

Referring to FIG. 2, an electronic device 101 (e.g., the electronic device 101 of FIG. 1) according to an embodiment may include a display 210 (e.g., the display device 160 of FIG. 1), a communication circuit 220 (e.g., the communication module 190 of FIG. 1), a memory 230 (e.g., the memory 130 of FIG. 1), and a processor 240 (e.g., the processor 120 of FIG. 1), and some of the components of FIG. 1 may be added.

According to an embodiment of the disclosure, the electronic device 101 may further include a blockchain management module 245. The blockchain management module 245 may be driven by blockchain management software (SW) (e.g., blockchain keystore).

The display 210 may output information related to the blockchain network under the control of the processor 240. The display 210 may output data processed by normal OS and data processed by security OS under the control of the processor 240.

The communication circuit 220 may transmit and receive data based on a blockchain network. For example, the blockchain network may be an Ethereum network, but the disclosure is not limited thereto.

According to an embodiment of the disclosure, the communication circuit 220 may transmit the smart contract to the blockchain network under the control of the processor 240. The smart contract transmitted to the blockchain may be synchronized with all nodes in the blockchain; thus, contents of the smart contract may be disclosed to all nodes in the blockchain. The smart contract is automated contract technology based on a blockchain, and may refer to a computer transaction protocol that executes contract conditions. For example, the smart contract may refer to a digital contract method in which contract conditions are coded based on blockchain technology and in which contents of the contract are executed when the conditions are met.

According to an embodiment of the disclosure, the communication circuit 220 may receive blockchain data (e.g., a message) when accessing a blockchain network or may transmit data (e.g., electronically signed message) signed with a private key stored in the electronic device 101 to the blockchain network.

The memory 230 may store information related to the blockchain. For example, the memory 230 may store at least one of a distributed application, a cryptocurrency wallet application, a blockchain security application, or a secure user interface application that may access a blockchain network. For example, the distributed application and the cryptocurrency wallet application may operate in a rich execution environment (REE), whereas the blockchain security application and the secure user interface application may operate in a trusted execution environment (TEE). When operating in a secure OS, stored data may be stored in an encrypted state. The electronic device 101 may include a separate secure storage area (e.g., embedded secure element (eSE), embedded subscriber identity module (eSIM)) for blockchain management in the memory 230.

According to an embodiment of the disclosure, the memory 230 may store blockchain management software (SW). The blockchain management software may be software (e.g., android package kit (APK) file) applied to a portable device, such as a smartphone. The blockchain management software may be embedded or installed in the electronic device 101. Alternatively, the blockchain management software may be downloaded from the server through an app store and installed in the electronic device.

The processor 240 may perform calculations or data processing related to control and/or communication of each component of the electronic device 101. The processor 240 may include at least some of the components and/or functions of the processor 120 of FIG. 1. The processor 240 may control the operation of the blockchain management module 245 based on blockchain management software.

According to an embodiment of the disclosure, the processor 240 may be operated separately as a general operating system (OS) and a secure OS. A resource area operated when the processor 240 is driven by a general OS may be understood as a general area, and a resource area operated when the processor 240 is driven by a secure OS may be understood as a secure area.

According to an embodiment of the disclosure, the processor 240 may control at least one of blockchain management software, a cryptocurrency application, or a distributed application to perform access, approval, and transaction operations of a blockchain network.

According to an embodiment of the disclosure, the blockchain management module 245 may operate by blockchain management software under the control of the processor 240. The blockchain management module 245 may interwork with a blockchain network related application to process data of a blockchain security application and a secure user interface application operating in a secure OS. The blockchain management module 245 may be understood in the same meaning as that of blockchain management software.

According to an embodiment of the disclosure, the blockchain management module 245 may apply an encryption algorithm based on a blockchain message when creating a wallet account through a cryptocurrency wallet application to generate a public key and a private key used in the blockchain network.

According to another embodiment of the disclosure, the blockchain management module 245 may apply an encryption algorithm based on a user's personal information and a blockchain message configured to the electronic device 101 when creating a wallet account, thereby creating a public key and a private key used in the blockchain network.

According to an embodiment of the disclosure, the blockchain management module 245 may generate a public key and a private key to form a pair. The private key generated by the blockchain management module 245 may be stored or recorded in the blockchain management software. The public key may be transferred to a blockchain network through a cryptocurrency wallet application and a decentralized application.

According to an embodiment of the disclosure, the blockchain management module 245 may perform an electronic signature on a message transferred through a cryptocurrency wallet application using a private key stored based on an encryption algorithm within a secure area.

According to an embodiment of the disclosure, the blockchain management module 245 may constitute a user authentication request screen for verifying signature authentication from the user based on a signature authentication request message transferred to the secure area. The processor 240 may control to output the authentication request screen to the display 210. The blockchain management module 245 may receive a user authentication input. The blockchain management module 245 may perform an electronic signature on the signature authentication request message using a private key stored in the secure area of the memory 230 in response to user authentication input information.

According to an embodiment of the disclosure, in the case that user personal information is included in the user authentication input information, the blockchain management module 245 may perform an electronic signature under the condition that the user personal information matches configured user personal information.

In the case that the user personal information does not match configured user personal information, the blockchain management module 245 may not perform electronic signature or may perform electronic signature with information different from a private key corresponding to the public key. In the case that the electronic signature is incorrect, the blockchain may recognize that the user account of the electronic device 101 is not a legitimate participant due to the incorrectly signed message.

According to an embodiment of the disclosure, the blockchain management module 245 may transfer the digitally signed message to a cryptocurrency wallet application operating in a general area of the memory.

According to an embodiment of the disclosure, the processor 240 may transfer the electronically signed message transferred to the cryptocurrency wallet application to the blockchain network through the distributed application. When verification of a participant in the blockchain network is completed, the electronic device 101 may use a blockchain network service.

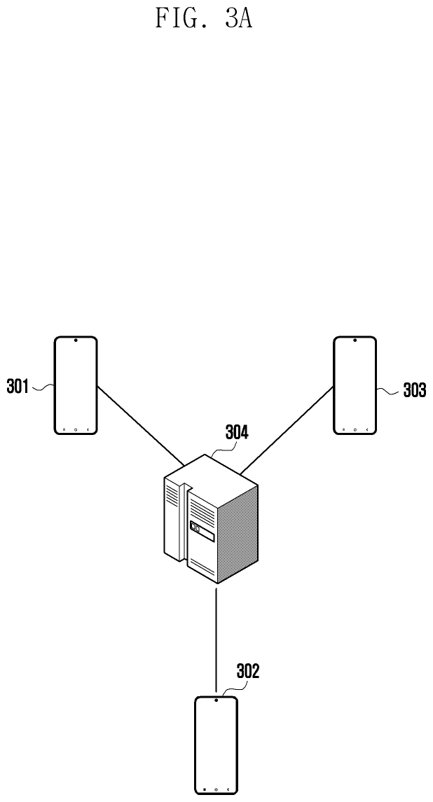

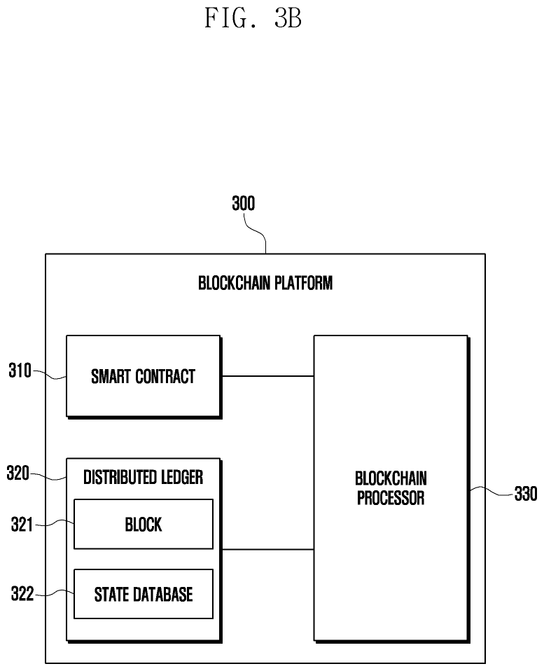

FIG. 3A is a diagram illustrating a mobile blockchain system according to an embodiment of the disclosure.

Referring to FIG. 3A, according to an embodiment of the disclosure, an electronic device (e.g., the electronic device 101 of FIG. 1) in a mobile blockchain network may form a blockchain network with at least one external electronic device through a communication module (e.g., the communication module 190 of FIG. 1). The electronic device 101 may transmit and receive data to and from at least one external electronic device included in the blockchain network and participate in a transaction consensus in the blockchain network.

According to an embodiment of the disclosure, the mobile blockchain network may include a plurality of electronic devices 301, 302, 303, and 304.

The plurality of electronic devices 301, 302, 303, and 304 may include a plurality of mobile nodes (or participating nodes) (e.g., 301, 302, 303) participating in the blockchain service and a relay node (or server node) (e.g., 304) connecting each mobile node. The mobile nodes (e.g., 301, 302, and 303) may be portable electronic devices (e.g., mobile phones, tablet PCs, or laptops). The relay node (e.g., 304) may be a server device.

According to an embodiment of the disclosure, the mobile nodes 301, 302, and 303 and the relay node 304 included in the blockchain network may store (or possess) a full ledger or a partial ledger, respectively.

According to an embodiment of the disclosure, the relay node 304 (or an electronic device serving as a relay) may be constituted to participate in execution of all transactions. The relay node 304 may record all blocks and consensus on all transactions in the blockchain network. The relay node 304 may participate in consensus on all transactions and store block and state data of all transactions in the blockchain network. The relay node 304 may store the full ledger, which is a distributed ledger of the blockchain network.

According to an embodiment of the disclosure, the relay node 304 may transfer a wakeup signal (e.g., push message) to the mobile node (e.g., 301, 302, or 303) in an inactive state (e.g., idle/sleep state). The mobile node (e.g., 301, 302, or 303) may switch to an active state (e.g., running state) corresponding to receiving a wake-up signal from the relay node 304 and connect to a blockchain network to participate in a blockchain network service. The mobile node (e.g., 301, 302, or 303) may receive a wakeup signal and transmit a response signal to the wakeup signal to the relay node 304. When the relay node 304 receives a response signal from the mobile node (e.g., 301, 302, or 303) participating in the transaction, the relay node 304 may relay to perform a transaction creation and consensus operation between nodes.

According to an embodiment of the disclosure, the mobile node (or electronic devices used as mobile nodes) (e.g., 301, 302, or 303) may generate a transaction and record a block related to each electronic device.

According to an embodiment of the disclosure, the mobile nodes (e.g., 301, 302, or 303) may be constituted to participate only in execution of transactions related to each electronic device. For example, the mobile node (e.g., 301, 302, or 303) may participate in a transaction consensus related to a user (or user device) among the full ledger of the blockchain network, and store only the block and state data (e.g., partial ledger) of the transaction. The mobile node (e.g., 301, 302, or 303) may store a partial ledger related to each electronic device among distributed ledgers of the blockchain network.

According to an embodiment of the disclosure, the mobile node (e.g., 301, 302, or 303) may execute a smart contract based on state data, and determine whether to execute a transaction based on the result of a consensus process performed between other mobile nodes and each other. For example, the mobile node (e.g., 301, 302, or 303) may execute the smart contract and determine that the consensus is successful in the case that generated result values match.

According to an embodiment of the disclosure, some (e.g., 301 or 302) of the mobile nodes participating in the blockchain network may store (or possess) a partial ledger of the distributed ledger of the blockchain network. The mobile node (e.g., 301 or 302) that stores the partial ledger may be a node requesting transaction creation in a blockchain network, and be a node performing a consensus operation on a transaction according to a transaction creation request.

FIG. 3B is a block diagram illustrating a constitution of a blockchain network according to an embodiment of the disclosure.

According to an embodiment of the disclosure, a blockchain platform 300 may correspond to a blockchain application that performs a blockchain related operation stored in the memory 130 of FIG. 1 or a blockchain module that performs a blockchain related operation included in the processor 120 of FIG. 1.

Referring to FIG. 3B, the blockchain platform 300 may include a smart contract 310, a distributed ledger 320, and/or a blockchain processor 330. In order to perform operations related to the blockchain, the blockchain platform 300 may further include various components or may omit some components.

In an embodiment of the disclosure, the distributed ledger 320 may store data on transactions related to the electronic device 101 in the blockchain network.

According to an embodiment of the disclosure, the distributed ledger 320 may be a partial ledger including at least a part of the full ledger rather than the full ledger of the blockchain network. For example, the distributed ledger 320 may include a partial ledger including blocks and data for transactions related to the electronic device 101 among the full ledger that stores blocks and data related to all transactions in the blockchain network.

According to another embodiment of the disclosure, the distributed ledger 320 may include a full ledger that stores blocks and data related to all transactions in the blockchain network.

According to an embodiment of the disclosure, the distributed ledger 320 may include at least one block 321 generated through the blockchain network and a state database 322. The block 321 may include transactions including information for executing the smart contract 310. In an embodiment of the disclosure, blocks of the distributed ledger 320 are made in the form of a blockchain and may include block data. For example, the block 321 may include a hash field and block data. The hash field may include previous block information in the full ledger of the blockchain network and previous block information in the partial ledger of the blockchain network.

According to an embodiment of the disclosure, at least one block 321 constituting the blockchain may be expressed as being connected based on previous block information included in the hash field. For example, at least one block 321 constituting a blockchain may be connected in a directed acyclic graph (DAG) structure. According to an embodiment of the disclosure, in the case that at least one block included in the full ledger of the blockchain network is connected in a DAG structure, the partial ledger of the blockchain network may be connected in a subgraph structure of the full ledger.

The state database 322 may store values changed due to transaction execution in the blockchain network in a key-value form. In an embodiment of the disclosure, data stored in the state database 322 may be expressed as state data. State data may refer to data stored in a world state, which is a database used in, for example, hyperledger fabric. However, the disclosure is not limited thereto.

The state database 322 is a kind of database used in hyperledger fabric, and may store final values changed by executing transactions in the form of key values. Accordingly, in order to identify final values by execution of transactions in the blockchain network, the electronic device 101 may identify the state database 322. State data stored in the state database 322 may have characteristics, such as global variables within the blockchain network.

According to an embodiment of the disclosure, the state database 322 may store data on a transaction in which a user of the electronic device 101 involves. For example, the state database 322 may store values changed due to execution of a transaction related to the electronic device 101 in the blockchain network.

According to an embodiment of the disclosure, the blockchain processor 330 may control the operation of components included in the blockchain platform 300. For example, the blockchain processor 330 may perform execution of transactions including synchronizing ledgers, signing transactions, and/or recording transactions on the blockchain network.

According to an embodiment of the disclosure, the blockchain processor 330 may perform an operation related to a blockchain network in which the electronic device 101 participates as a node (e.g., mobile node). According to an embodiment of the disclosure, the blockchain processor 330 may form a blockchain network and perform operations related to other nodes (external electronic devices) included in the blockchain network.

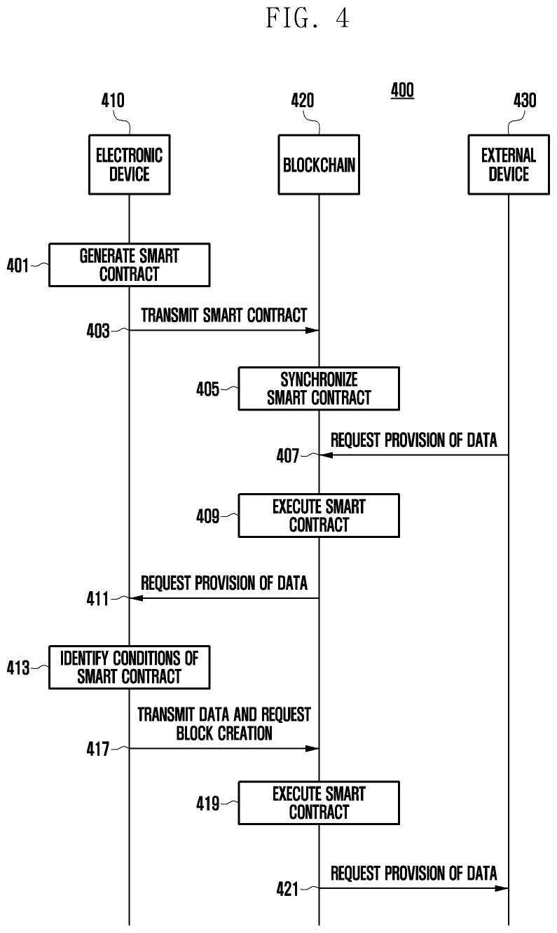

FIG. 4 is an operation flow diagram illustrating a relationship between an electronic device, a blockchain, and an external device according to an embodiment of the disclosure.

Referring to an operation flow diagram 400 of FIG. 4, an electronic device 410 (e.g., the electronic device 101 of FIG. 1) may transmit a smart contract for transmission of shared data to a blockchain 420, and an external device 430 (e.g., a server of a company providing services) may request to provide personal information to the blockchain 420 (or blockchain network) and receive shared data from the blockchain 420 based on a smart contract.

According to an embodiment of the disclosure, in operation 401, the electronic device 410 may generate a smart contract. The smart contract may be, for example, a contract for personal information transaction between a user of the electronic device 410 and the external device 430. The external user means a user of the external device. The external device may include information on the external user, and an operation performed by the external device may be recognized as an operation performed by the external user. The smart contract may include shared data of the electronic device and information on an external user to receive the shared data.

According to an embodiment of the disclosure, the processor (e.g., the processor 240 of FIG. 2) of the electronic device 410 may generate a smart contract related to transmission of shared data. The smart contract related to transmission of shared data may include, for example, information on data to be provided to external users and information on external users to provide personal information. Contents included in the smart contract may be configured by the user of the electronic device 410. The processor 240 may control the display 230 to output a configuration screen capable of configuring shared data to be provided to external users and external users to receive the shared data.

In operation 403, the electronic device 410 may transmit the smart contract to the blockchain 420.

In operation 405, the transmitted smart contract may be synchronized on the blockchain 420. The smart contract synchronized with the blockchain 420 is disclosed to all users (e.g., multiple nodes) within the blockchain 420 and stored in a distributed manner. In the case of a transaction through the smart contract based on the blockchain 420, transparency of the transaction may be increased, and stability against forgery/falsification may be increased.

In operation 407, the external device 430 may request the blockchain 420 to provide data. The external device 430 may request, for example, desired data with a query. The query may mean a request from a specific subject (e.g., the external device 430) requesting to show specific data to the database. In operation 409, the blockchain 420 may execute the smart contract based on the data provision a request of the external device 430. In the case that the blockchain 420 receives request for personal information from the external device 430 with a query, a smart contract synchronized with the blockchain 420 may be executed. In the case that a smart contract synchronized with the blockchain 420 is executed, the blockchain 420 may transmit a data provision request to the electronic device 410 in response to execution of the smart contract. In operation 411, the blockchain 420 may transmit a data provision request according to execution of the smart contract to the electronic device 410. The blockchain 420 according to an embodiment may identify whether data requested by the external device 430 meets data provision conditions on the smart contract. In the case that personal information requested by the external device 430 meets information provision conditions in the smart contract, the blockchain 420 may transmit a data provision request to the electronic device 410, which is a party of the smart contract. In the case that personal information requested by the external device 430 does not meet data provision conditions in the smart contract, the blockchain 420 may not execute the smart contract. In the case that the smart contract is not executed, the blockchain 420 may not transmit the data provision request to the electronic device 410.

In operation 413, the electronic device 410 may identify whether the data provision request of the external device 430 meets data provision conditions included in the smart contract. For example, the electronic device 410 may identify whether the external user of the external device 430 that has requested the data corresponds to the external user to receive data included in the smart contract, and whether data requested by the external device 430 is included in an information category that may be provided to the external user included in the smart contract.

In an embodiment of the disclosure, in the case that data requested by the external device 430 meets data provision conditions in the smart contract, the electronic device 410 may process information to meet an information de-identification level in the smart contract. The method of processing data may be a method of de-identifying data using at least one method of, for example, pseudonymization, aggregation, data reduction, data suppression, data masking, or differential privacy.

In operation 417, the electronic device 410 may transmit the processed information to the blockchain 420. A method of transmitting to the blockchain 420 may be, for example, a method for the electronic device 410 to perform a transaction. The smart contract transmitted to the blockchain 420 may be executed through a transaction performed by the electronic device 410.

In operation 419, the blockchain 420 may execute the smart contract in response to receiving the processed information from the electronic device 410. The transaction performed by the electronic device 410 may execute the smart contract on the blockchain 420.

In operation 421, the blockchain 420 may transmit processed data to the external device 430 in response to the execution of the smart contract.

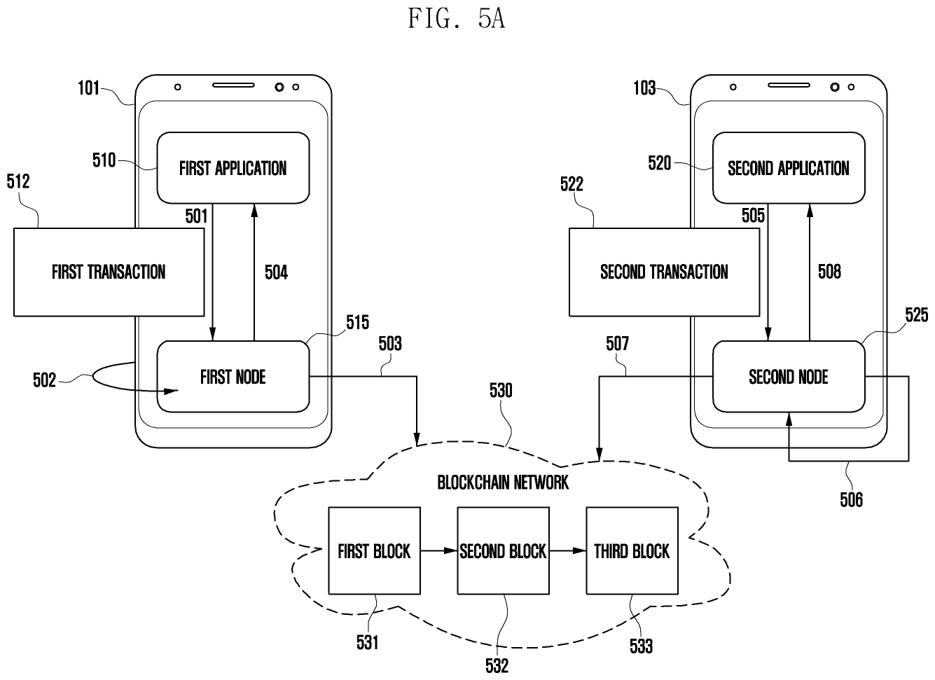

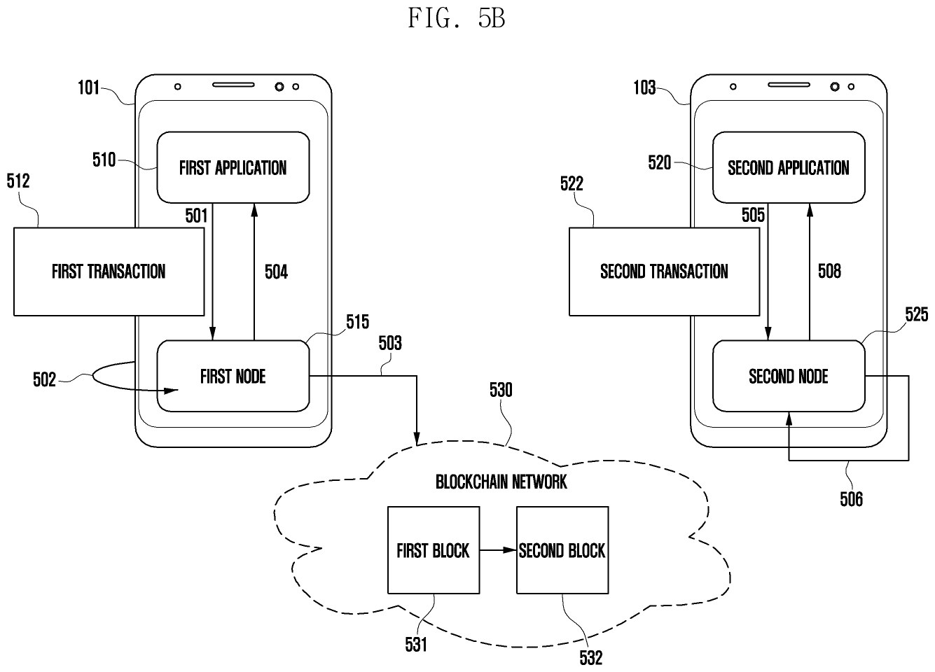

FIG. 5A illustrates a data transmission situation through a blockchain of an electronic device according to an embodiment of the disclosure.

Referring to FIG. 5A, in an embodiment of the disclosure, the electronic device 101 may include a first application 510 and a first node 515. The first node 515 may mean, for example, a specific application running on the electronic device 101. The specific application may provide functions related to acting as nodes in a blockchain. The first node 515 may perform ledger management. In the ledger, information of a subject who wants to transfer data, data to transfer, and the right of a limited recipient may be recorded. The first node 515 may serve as a node of the blockchain.

In an embodiment of the disclosure, the first application 510 may use the first node 515. The first application 510 may store the smart contract in an uncompiled state. The first application 510 may request creation of a transaction to the first node 515 for data to be recorded in the blockchain ledger. The transaction may refer to a unit of work performed to change a state of a database.

In operation 501, the first application 510 may request creation of a first transaction 512 to the first node 515. The first transaction 512 may include data (e.g., key1/data1) wanting to share and information on a target to allow sharing. The first application 510 may allow sharing of only a limited application (e.g., a second application 520) or may allow sharing to all applications (or user terminals) without limitation. The subject to allow sharing is not limited thereto, and may vary according to configurations on the first application 510.

In operation 502, the first node 515 may perform verification on the first transaction 512. The first node 515 may verify who signatories of the transaction are. The first node 515 may verify whether a factor value of the smart contract is correct. The first node 515 may identify whether the smart contract is normally executable.

In operation 503, the first node 515 may request block creation to a consensus node (not illustrated). When a block is created, the first node 515 may notify the node constituting a blockchain network 530 of the block creation fact. The consensus node may create a block based on transaction submission requests. The consensus node may have original data of the ledger. The consensus node may have an address having original data and a hash value, not the original data according to the configuration of the blockchain network 530. The blockchain network 530 may connect and store created blocks (e.g., a first block 531 and a second block 532). The first block 531 and the second block 532 may be created based on a transaction submission request of the consensus node. The second block 532 may be created after the first block 531 is created, and be connected to the first block 531.

In operation 504, the first node 515 may notify the first application 510 of the verified transaction and block creation fact.

In an embodiment of the disclosure, the external device 103 may include a second application 520 and a second node 525. The second node 525 may perform ledger management. In the ledger, information of a subject who wants to transfer data, data to transfer, and the right of a limited recipient may be recorded. The second node 525 may serve as a node of the blockchain. The second application 520 may use the second node 525. The second application 520 may store the smart contract in an uncompiled state. The second application 520 may request creation of a transaction to the second node 525 for data to be recorded in the blockchain ledger.

In operation 505, the second application 520 may request creation of a second transaction 522 to the second node 525. The second transaction 522 may include information on data to receive. The information on data to receive may include, for example, information on a data1 value corresponding to key1 among app1data.

In operation 506, the second node 525 may perform verification on the second transaction 522. The second node 525 may verify who signatories of the transaction are. The second node 525 may verify whether a factor value of the smart contract is correct. The second node 525 may identify whether the smart contract is normally executable. The second node 525 may acquire information on a subject to allow sharing in the smart contract. The second node 525 may identify whether the second application 520 is included in the target to allow sharing.

In operation 507, the second node 525 may request block creation to a consensus node (not illustrated) based on identifying that the second application 520 is included in the target to allow sharing. When a block is created, the second node 525 may notify the node constituting the blockchain network 530 of the block creation fact. The node constituting the blockchain network 530 may connect a corresponding block (e.g., a third block 533) to existing blocks (e.g., the first block 531 and the second block 532). The third block 533 may be created temporally after the first block 531 and the second block 532 are created.

In operation 508, the second node 525 may notify the second application 520 of the verified transaction and block creation fact. The second node 525 may transfer data requested by the second application 520 to the second application 520.

FIG. 5B illustrates a situation in which an electronic device rejects a data transmission request of an application that is not permitted according to an embodiment of the disclosure.

Referring to FIG. 5B, in an embodiment of the disclosure, the electronic device 101 may include a first application 510 and a first node 515. The first node 515 may perform ledger management. In the ledger, information of a subject who wants to transfer data, data to transfer, and the right of a limited recipient may be recorded. The first node 515 may serve as a node of a blockchain. The first application 510 may use the first node 515. The first application 510 may store the smart contract in an uncompiled state. The first application 510 may request creation of a transaction to the first node 515 for data to be recorded in the blockchain ledger.

In operation 501, the first application 510 may request creation of a first transaction 512 to the first node 515. The first transaction 512 may include data (e.g., key1/data1) wanting to share and information (e.g., a second application 520 or a second user) on a target to allow sharing.

In operation 502, the first node 515 may perform verification on the first transaction 512. The first node 515 may verify who signatories of the transaction are. The first node 515 may verify whether a factor value of the smart contract is correct. The first node 515 may identify whether the smart contract is normally executable.

In operation 503, the first node 515 may request block creation to a consensus node (not illustrated). When a block is created, the first node 515 may notify the node constituting a blockchain network 530 of the block creation fact.

In operation 504, the first node 515 may notify the first application 510 of the verified transaction and block creation fact.

In an embodiment of the disclosure, the external device 103 may include a second application 520 and a second node 525. The second node 525 may perform ledger management. In the ledger, information of a subject who wants to transfer data, data to transfer, and the right of a limited recipient may be recorded. The second node 525 may serve as a node of the block chain. The second application 520 may use the first node 525. The second application 520 may store the smart contract in an uncompiled state. The second application 520 may request creation of a transaction to the second node 525 for data to be recorded in the blockchain ledger.

In operation 505, the second application 520 may request creation of a second transaction 522 to the second node 525. The second transaction 522 may include information on data to receive. The information on data to receive may include, for example, information on a data1 value corresponding to key1 among app1data.

In operation 506, the second node 525 may perform verification on the second transaction 522. The second node 525 may verify who signatories of the transaction are. The second node 525 may verify whether a factor value of the smart contract is correct. The second node 525 may identify whether the smart contract is normally executable. The second node 525 may acquire information on a subject to allow sharing in the smart contract. The second node 525 may identify whether the second application 520 is included in the target to allow sharing. The second node 525 may not transmit the second transaction 522 to the blockchain network 530 based on identifying that the second application 520 is not included in the target to allow sharing.

In operation 508, the second node 525 may transmit a signal (e.g., fail indication) indicating that the requested data cannot be sent to the second application 520.

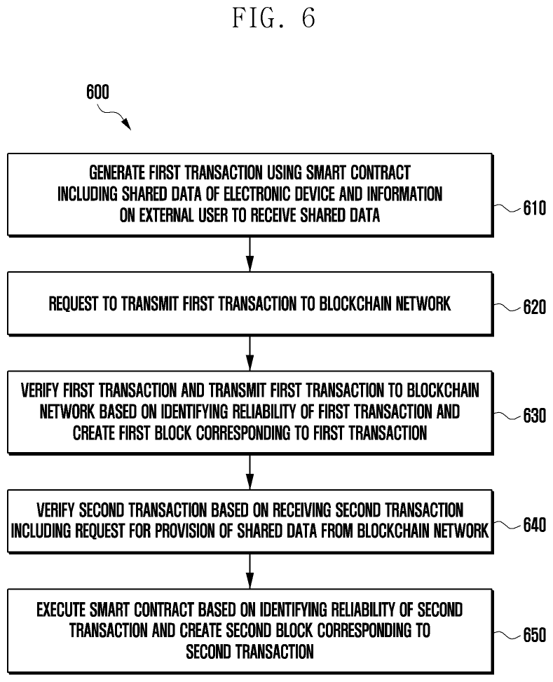

FIG. 6 is a flowchart illustrating a method of managing data of an electronic device according to an embodiment of the disclosure.

Referring to FIG. 6, operations described may be implemented based on instructions that may be stored in a computer recording medium or memory (e.g., the memory 130 of FIG. 1). The illustrated method 600 may be executed by the electronic device (e.g., the electronic device 101 of FIG. 2) previously described with reference to FIGS. 1, 2, 3A, 3B, 4, 5A, and 5B, and technical features described above will be omitted below. The order of each operation in FIG. 6 may be changed, some operations may be omitted, or some operations may be performed simultaneously.

In operation 610, the processor (e.g., the processor 240 of FIG. 2) may generate a first transaction using a smart contract including shared data of the electronic device 101 and information on an external user to receive the shared data. The transaction may refer to a unit of work performed by changing a state of a database.

In operation 620, the processor 240 may request to transmit the first transaction to a blockchain network (e.g., the blockchain network 530 of FIG. 5A).

In operation 630, the processor 240 may request to create a first block (e.g., the first block 531 of FIG. 5A) corresponding to the first transaction to a first node (e.g., the first node 515 of FIG. 5A). The first node 515 may verify the first transaction. The first node 515 may perform ledger management. In the ledger, information of a subject who wants to transfer data, data to transfer, and the right of a limited recipient may be recorded. The first node 515 may serve as a node of a blockchain. The first node 515 may transmit the first transaction to the blockchain network based on identifying reliability of the first transaction and create a first block 531 corresponding to the first transaction. The electronic device 101 may include a first node 515 creating a block. The electronic device 101 may verify reliability of data requesting block creation using the first node 515. For example, the electronic device 101 may simultaneously request creation of a non-fungible token (NFT) while storing a file created in a verified application in the memory (e.g., the memory 230 of FIG. 2). Because the application has already been verified, the electronic device 101 may identify that the file requested to create a non-fungible token (NFT) was created by a specific user. The first node 515 may have the form of an application or the form of a server. The first node 515 may further include a value corresponding to an owner in addition to a key and a value. The processor 240 may verify a user having the right to change values of a key and a value using a value corresponding to the owner.

In operation 640, the processor 240 may receive a second transaction including a request for provision of shared data from the blockchain network 530. The processor 240 may request verification of the second transaction to the first node 515.

In operation 650, the first node 515 may execute the smart contract based on identifying reliability of the second transaction. The first node 515 may create a block corresponding to the second transaction.

In an embodiment of the disclosure, the first node 515 may request block creation to a consensus node (not illustrated). When a block is created, the first node 515 may notify the node constituting the blockchain network 530 of the block creation fact. The consensus node may create blocks based on transaction submission requests. The consensus node may have original data of the ledger. The consensus node may have an address having original data and a hash value, not the original data according to a constitution of the blockchain network 530.

In an embodiment of the disclosure, in the case that reliability of the second transaction is not identified, the first node 515 may return the second transaction to the second node (e.g., the second node 525 of FIG. 5A). In the case that information on the second node 525 requesting execution of the second transaction does not match information on the external user to receive shared data, the first node 515 may return the second transaction to the second node 525. The first node 515 may reject creation of a block corresponding to the second transaction.

In an embodiment of the disclosure, an electronic device (e.g., the electronic device 101 of FIG. 1) may include a communication circuit (e.g., the communication circuit 220 of FIG. 2); a memory (e.g., the memory 230 of FIG. 2) configured to store a partial ledger including a part of a full ledger for a blockchain network or the full ledger; and a processor (e.g., the processor 240 of FIG. 2), wherein the ledger may include at least one block corresponding to each of at least one transaction in which the electronic device 101 participated in a consensus. The processor 240 may be configured to generate a first transaction using a smart contract including shared data of the electronic device and information on an external user to receive the shared data, to request to transmit the first transaction to the blockchain network, to verify the first transaction using a node creating at least one block corresponding to each of at least one transaction in which the electronic device participates in a consensus, to transmit the first transaction to the blockchain network based on identifying reliability of the first transaction, to create a first block corresponding to the first transaction, to verify a second transaction based on receiving a second transaction including a request for provision of the shared data from the blockchain network, to execute the smart contract based on identifying reliability of the second transaction, and to create a second block corresponding to the second transaction.

According to an embodiment of the disclosure, the node may be configured to verify the second block and to record on the blockchain network based on verification of the second block.

According to an embodiment of the disclosure, the processor 240 may be configured to request to update a ledger of each node participating in the blockchain network using the communication circuit based on completion of transaction consensus between the external device and the blockchain network.

According to an embodiment of the disclosure, the processor 240 may be configured to identify whether the smart contract is executed using the ledger in the blockchain network and whether shared data of the electronic device is shared.

According to an embodiment of the disclosure, the electronic device and an external device may be mobile nodes, and the processor may be configured to communicate with the external device through a relay node in the blockchain network.

According to an embodiment of the disclosure, the processor 240 may be configured to control a display to output a configuration screen capable of configuring shared data of the electronic device and information on an external user to receive the shared data.

According to an embodiment of the disclosure, the node may be configured to execute the second transaction based on information on the external user to receive shared data in the second transaction and information on the external user to receive the shared data recorded in the smart contract being matched, and to create a block including information indicating that the shared data has been transmitted to an external device.

According to an embodiment of the disclosure, the node may be configured to verify the second transaction, and to execute the second transaction based on reliability of the second transaction being verified.

A server may include a communication circuit 220; a memory 230 configured to store a partial ledger including a part of a full ledger or the full ledger; and a processor 240. The processor may be configured to receive a first transaction including a smart contract related to shared data and information on an external user to receive the shared data from a first node of a first external device, to request verification to the first node whether information on an external user to receive the shared data in the smart contract and information on the second external device matches based on receiving a second transaction including a request for provision of the shared data from a second node of a second external device, and to transmit the shared data to the second external device based on the second external device and information on an external user to receive the shared data being matched in the smart contract.

According to an embodiment of the disclosure, the processor may be configured to record a first block corresponding to the first transaction on a blockchain network based on completion of verification of the first transaction from the first node.

According to an embodiment of the disclosure, the processor may be configured to record a second block corresponding to the second transaction on a blockchain network based on completion of verification of the second transaction from the first node.

According to an embodiment of the disclosure, the processor may be configured to transmit shared data to the second external device based on completion of verification of the second transaction from the first node, and to transmit information indicating that the second external device has received the shared data to the first node.

A method of managing data transmission of an electronic device 101 may include generating a first transaction using a smart contract including shared data of the electronic device 101 and information on an external user to receive the shared data; requesting to transmit the first transaction to a blockchain network; verifying the first transaction and transmitting the first transaction to the blockchain network based on identifying reliability of the first transaction; creating a first block corresponding to the first transaction; verifying second transaction based on receiving a second transaction including a request for provision of shared data from the blockchain network; and executing the smart contract based on identifying reliability of the second transaction and creating a second block corresponding to the second transaction.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a communication circuit;
a memory configured to store a partial ledger including a part of a full ledger for a blockchain network or the full ledger; and
a processor electrically connected to the communication circuit and the memory,
wherein the full ledger comprises at least one block corresponding to each of at least one transaction in which the electronic device participates in a consensus, and
wherein the processor is configured to:
generate a first transaction using a smart contract including shared data of the electronic device and information on an external user to receive the shared data,
request to transmit the first transaction to the blockchain network,
verify the first transaction using a node creating at least one block corresponding to each of at least one transaction in which the electronic device participates in a consensus,
transmit the first transaction to the blockchain network based on identifying reliability of the first transaction, and create a first block corresponding to the first transaction,
verify a second transaction based on receiving the second transaction including a request for provision of the shared data from the blockchain network,
execute the smart contract based on identifying reliability of the second transaction, and
create a second block corresponding to the second transaction.

2. The electronic device of claim 1, wherein the node is configured to:
verify the second block; and
record on the blockchain network based on verification of the second block.

3. The electronic device of claim 1, wherein the processor is further configured to request to update a ledger of each node participating in the blockchain network using the communication circuit based on completion of a transaction consensus between an external device and the blockchain network.

4. The electronic device of claim 3, wherein the processor is further configured to identify whether the smart contract is executed using the ledger in the blockchain network and whether shared data of the electronic device is shared.

5. The electronic device of claim 1,
wherein the electronic device and an external device are mobile nodes, and
wherein the processor is further configured to communicate with the external device through a relay node in the blockchain network.

6. The electronic device of claim 1, wherein the processor is further configured to control a display to output a configuration screen capable of configuring shared data of the electronic device and information on an external user to receive the shared data.

7. The electronic device of claim 1, wherein the node is configured to:
execute the second transaction based on information on the external user to receive the shared data in the second transaction and information on the external user to receive the shared data recorded in the smart contract being matched; and
create a block including information indicating that the shared data has been transmitted to an external device.

8. The electronic device of claim 1, wherein the node is configured to:
verify the second transaction; and
execute the second transaction based on reliability of the second transaction being verified.

9. A server, comprising:
a communication circuit;
a memory configured to store a partial ledger including a part of a full ledger or the full ledger; and
a processor,
wherein the processor is configured to:
receive a first transaction including a smart contract related to shared data and information on an external user to receive the shared data from a first node of a first external device,
request verification to the first node whether information on an external user to receive the shared data in the smart contract and information on a second external device matches based on receiving a second transaction including a request for provision of the shared data from a second node of the second external device, and
transmit the shared data to the second external device based on the second external device and information on an external user to receive the shared data being matched in the smart contract.

10. The server of claim 9, wherein the processor is further configured to record a first block corresponding to the first transaction on a blockchain network based on completion of verification of the first transaction from the first node.

11. The server of claim 9, wherein the processor is further configured to record a second block corresponding to the second transaction on a blockchain network based on completion of verification of the second transaction from the first node.

12. The server of claim 9, wherein the processor is further configured to:
transmit the shared data to the second external device based on completion of verification of the second transaction from the first node; and
transmit information indicating that the second external device has received the shared data to the first node.

13. A method of managing data transmission of an electronic device, the method comprising:
generating a first transaction using a smart contract including shared data of the electronic device and information on an external user to receive the shared data;
requesting to transmit the first transaction to a blockchain network;
verifying the first transaction and transmitting the first transaction to the blockchain network based on identifying reliability of the first transaction;
creating a first block corresponding to the first transaction;
verifying a second transaction based on receiving the second transaction including a request for provision of the shared data from the blockchain network;
executing the smart contract based on identifying reliability of the second transaction; and
creating a second block corresponding to the second transaction.

14. The method of claim 13, wherein the electronic device further comprises a node, the node being configured for:
verifying the second block; and
recording on the blockchain network based on verification of the second block.

15. The method of claim 13, further comprising:
requesting to update a ledger of each node participating in the blockchain network using a communication circuit based on completion of a transaction consensus between an external device and the blockchain network.

16. The method of claim 14, further comprising:
identifying whether the smart contract is executed using the ledger in the blockchain network and whether shared data of the electronic device is shared.

17. The method of claim 13, wherein the electronic device further comprises a node, the node being configured for:
executing the second transaction based on information on the external user to receive the shared data in the second transaction and information on the external user to receive the shared data recorded in the smart contract being matched; and
creating a block including information indicating that the shared data has been transmitted to an external device.

18. The method of claim 13, wherein the electronic device further comprises a node, the node being configured for:
verifying the second transaction; and
executing the second transaction based on reliability of the second transaction being verified.

19. The method of claim 14, wherein the recording on the blockchain network further comprises:
recording the first block corresponding to the first transaction on the blockchain network based on completion of verification of the first transaction from the first node.

20. The method of claim 19, wherein the recording on the blockchain network further comprises:
recording the second block corresponding to the second transaction on the blockchain network based on completion of verification of the second transaction from the first node.
